(19) United States
(12) Patent Application Publication
(10) Pub. No.: US 2011/0024404 A1
(43) Pub. Date: Feb. 3, 2011

(54) EXCHANGEABLE MODULE FOR A MACHINING HEAD OF A LASER MACHINING TOOL

(75) Inventor: Marco Belletti, Walliswil Bei Wangen (CH)

Correspondence Address: COLLARD & ROE, P.C., 1077 NORTHERN BOULEVARD, ROSLYN, NY, 11576, US

(73) Assignee: Bystronic Laser AG, Niederoenz (CH)

(21) Appl. No.: 12/734,802

(22) PCT Filed: Nov. 25, 2008
(86) PCT No.: PCT/CH2008/000496

§ 371 Date: Oct. 12, 2010

(30) Foreign Application Priority Data
Nov. 26, 2007 (EP) 07405334.9

(51) Int. Cl. B23K 26/00

(52) U.S. Cl. 219/121.67

(57) ABSTRACT

The invention relates to an exchangeable module (20) for a modular machining head (10) of a laser machining tool (1) for machining a workpiece (2) by means of a laser beam (5), the carrying structure (30) of which is configured as a hollow part and a driven part is configured as piston unit (26), which is disposed in a cavity of the hollow part and which is guided on a cavity wall (45) of the cavity. The piston unit (26) encompasses a passage duct (29) for the laser beam (5) and a focusing lens (25) is disposed in the passage duct and is attached to the piston unit. The piston unit (26) encompasses opposite piston surfaces (41.1, 42.1), and to which fluid pressure can be applied in each case, so that the focusing lens (25) is capable of being moved forwards and backwards across a readjusting area as a function of the pressure application of the opposite piston surfaces (41.1, 42.2), and is capable of being held fluidically at any position of this readjusting area. The invention furthermore relates to a combination of a modular machining head and this exchangeable module, as well as to a laser machining tool comprising this combination.

The invention relates to a modular machining head for a laser machining tool for machining a workpiece by means of a laser beam, to an exchangeable module for such a machining head and to a laser machining tool having such a machining head.

A machining head of a laser machining tool represents the last element of a beam control of a laser beam, which is used for machining a workpiece by means of the laser machining tool. As a rule, a machining head has the object of focusing the laser beam onto the workpiece, which is to be machined, or onto the workpieces, which are to be machined, respectively, and, if applicable, to additionally guide a process gas or a plurality of different process gases into the environment of the focal point of the respective laser beam, so as to impact the machining processes (for example cutting of a workpiece, welding of a plurality of workpieces, manufacturing engravings on surfaces or the like), which are induced by the laser beam, by means of the respective process gas. As a rule, a machining head thus comprises at least one focusing lens and an adjusting mechanism, which serves the purpose of adjusting the focusing lens, so as to be able to change the distance of the focusing lens relative to the workpiece, which is to be machined, and to thus be able to impact the position of the focal point relative to the workpiece. As a rule, a machining head furthermore comprises a series of sensors for detecting different operating parameters (for example for controlling the position of the machining head, for monitoring the quality of the respective result of a machining by means of the laser beam, for monitoring the integrity of the focusing lens or the like), an electronic system for processing the respective sensor signals and for communicating with a control system of the laser machining tool and a delivery of different media (for example for supplying with energy and/or with coolants and/or with the gases, which are required for carrying out machining processes).

As a rule, the focusing lens of a machining head of a laser machining tool must be replaced relatively frequently. There are various reasons for this. On the one hand, the optical elements of a focusing lens can in each case be wearing parts, which withstand an impact of the laser beam, which is to be focused, only for a limited period in response to a high light intensity of the laser beam and which must thus be replaced after reaching a certain life cycle. For the most part, laser machining tools are furthermore designed such that different machining processes can be carried out, which require in each case different focusing lenses, for example focusing lenses having different focal widths and/or different diameters.

To provide for a simple replacement of the respective focusing lens, laser machining tools often encompass a modularly designed machining head, which is comprised of a stationary part and of a replaceable exchangeable module, which comprises at least one focusing lens. The term “stationary part” of the machining head refers herein to all components of the machining head, with the exception of the exchangeable module, that is, to all components of the machining head, from which the respective exchangeable module can be separated (in response to the removal of the respective exchangeable module from the “stationary part”), without having to separate the “stationary part” into individual components.

A conventional modular machining head, which corresponds to this concept, is known from DE 196 28 857 A1. In this example, a focusing lens consists of one lens or of a plurality of lenses. The respective lenses are in each case installed into a cartridge, wherein the position of the respective lenses relative to the cartridge can be preset by means of positioning rings in longitudinal direction of the optical axis of the focusing lens. A cartridge, which is configured in such a manner, forms an exchangeable module of the machining head. In a stationary part of the machining head, such an exchangeable module can be inserted into or pulled out of a carrying unit for the exchangeable module, respectively, at right angles to the expansion direction of the laser beam via a duct-like space, which is configured in the stationary part, wherein the cartridge of the exchangeable module is guided exclusively at right angles to the expansion direction of the laser beam in the carrying unit, so as to prevent a readjustment of the exchangeable module in axial direction (that is, in expansion direction of the laser beam) relative to the carrying unit. The carrying unit is substantially configured in a hollow-cylindrical manner and is guided on one side in a ring-shaped duct, which is located coaxially to the expansion direction of the laser beam and which is located in a housing part of the machining head. In the instant case, the carrying unit for the respective exchangeable module is thus a component of the stationary part of the machining head. The stationary part of the machining head furthermore comprises a drive device for displacing the carrying unit in the expansion direction of the laser beam. The drive device is fixedly assembled in the interior of the (stationary part of the) machining head and comprises an electrically driven drive motor, a drive wheel, which is fastened to the motor shaft of the motor, a toothed belt, which is driven by means of this drive wheel, and a shaft, which is driven by means of the toothed belt. Said shaft is connected to the carrying unit for the exchangeable module and ensures a readjusting of the carrying unit in the longitudinal direction of the laser beam, in the event that the shaft is driven by means of the drive motor. In the instant case, all of the driven parts of the drive device are thus fixedly mounted in the stationary part of the machining head. It is also proposed that the drive device can be a pneumatic drive device, wherein, however, information is not provided as to how a pneumatic drive could be configured concretely or how it could be integrated into the machining head, respectively. In the stationary part of the machining head, between the focusing lens and an outlet opening for the laser beam, a pressure space is disposed, into which a pressurized process gas can be introduced and out of which the respectively introduced process gas can escape via the mentioned outlet opening for the laser beam in the form of a gas flow. To compensate for the forces, which are transferred from the process gas, which is introduced into the pressure space, to the focusing lens, the carrying unit for the exchangeable module is disposed such that it projects into a pressure chamber at the end, which faces away from the outlet opening for the laser beam, wherein an operating pressure prevails in this pressure chamber, which is such that the carrying unit is kept balanced. To obtain a pressure balance between pressure space and pressure chamber in a simple manner, the pressure space and the pressure chamber are connected to one another via at least one connection canal, so that the pressure chamber is also filled with the process gas, which is filled into the pressure space.

A modular machining head of the afore-mentioned type has various disadvantages. For example, not only the focusing lens is to be considered to be a wearing part. The drive device for adjusting the focusing lens and in particular the driven parts of the drive device must be serviced frequently and have a relatively short life cycle. Due to the fact that the entire drive device is fixedly mounted in the stationary part of the machining head, the laser machining tool must be stopped in each case for servicing the drive device or for replacing wearing parts of the drive device, which leads to a reduction of the productivity of the laser machining tool. The demands, which are to be made on a drive device for adjusting a focusing lens, furthermore substantially depend on the characteristics of the respective focusing lens. For example, the dimensions, the weight or the depth of focus of the focusing lens must be considered when designing the drive device, so as to make it for the focusing lens to be positioned in a sufficiently quick and accurate manner relative to the workpiece, which is to be machined. A drive device, which is to be fixedly mounted in the stationary part of a machining head, must thus be designed such that it can preferably be operated together with a plurality of different focusing lenses. This is associated with the disadvantage that a fixedly mounted drive device limits the choice of the focusing lenses, which can be used together with the drive device. As a rule, a focusing lens would furthermore be operated together with a drive device, which more than meets the minimum requirements given by the focusing lens. As a rule, the drive device will thus be configured so as to be more efficient than necessary—measured by these minimum requirements.

The instant invention is based on the object of avoiding the mentioned disadvantages and to propose a modular machining head of a laser machining tool, which is configured so as to be easy to service and which can in each case be equipped with a drive device, which is optimized with reference to the respective focusing lens.

This object is solved according to the invention by means of an exchangeable module comprising the features of patent claim 1, a modular machining head comprising the features of patent claim 22 and a laser machining tool comprising the features of patent claim 23.

The machining head according to the invention comprises a stationary part and a replaceable exchangeable module, wherein the respective exchangeable module comprises a focusing lens for focusing the laser beam and wherein a drive device is available for moving and/or adjusting the focusing lens. It is presumed that the drive device comprises at least one driven part, wherein the respective driven parts can be moved relative to the stationary part of the machining head and the focusing lens is coupled to at least one driven part of the drive device such that the position of the focusing lens can be changed relative to the stationary part to the machining head.

The exchangeable module comprises the focusing lens, the respective driven parts of the drive device and a carrying structure for the focusing lens and the respective driven parts of the drive device, wherein the carrying structure can be brought into a stationary operating position with reference to the stationary part of the machining head and the focusing lens and the respective driven parts of the drive device are disposed on the carrying structure such that the focusing lens can be moved relative to the carrying structure by means of the drive device.

Due to the fact that the respective driven parts of the drive device for the focusing lens are also integrated into the exchangeable module, the respective focusing lens as well as at least those parts of the drive device, which must be serviced with particular frequency or which wear rapidly, are combined in an exchangeable module and are easily accessible, as soon as the exchangeable module is separated from the stationary part of the machining head. All of the components of the exchangeable module, in particular the focusing lens and the driven parts of the drive device can be serviced, repaired or replaced comfortably after removing the machining head. After removing an exchangeable module, the modular machining head can immediately be equipped with another suitable exchangeable module. By providing a plurality of suitable exchangeable module, interruptions of the operation of the laser machining tool, which are associated with the focusing lens, can thus be avoided for the most part.

According to the invention, the modular machining head comprises a drive unit, which is configured as a fluid drive. In this case, at least one of the respective driven parts of the drive unit can be driven and thus be moved by means of a pressurized fluid (for example by means of a gas or a hydraulic fluid). A fluidically driven part can be integrated into an exchangeable module in a simple manner and can be combined with a focusing lens in a simple manner. The driven part can be a fluidically drivable piston surface, for example. It can be disposed concentrically around the optical axis of a focusing lens and can, for example, encompass the form of a ring, which is concentric relative to the expansion direction of the laser beam.

Based on this, an exchangeable module, which encompasses a plurality of advantages, can be realized. The drive unit can be realized, can be configured so as to be compact, can encompass a low weight and can be manufactured in a cost-efficient manner by means of a few components, for example. The fluid drive furthermore provides for a rapid readjusting of the focusing lens (for example at a speed, which is greater by a factor of 3-5) as compared to electromechanical drives.

To provide for a simple replacement of an exchangeable module, the respective exchangeable module can be configured as a slide-in, for example, which can be inserted into the stationary part of the machining head and which can be removed accordingly radially or parallel to the expansion direction of the laser beam.

Due to the fact that the respective driven parts of the drive device for the focusing lens are also integrated into the exchangeable module, it is furthermore possible to equip the respective exchangeable module with components of a drive device, which is optimized in view of the requirements of the respective focusing lens. Various focusing lenses can thus in each case be combined with various drive devices or with various components of a drive device.

A drive device or the driven parts of a drive device can in each case be integrated into an exchangeable module, wherein the drive device can be designed as a function of characteristics of the respective focusing lens. The driven parts of the respective drive device can be dimensioned differently in each case, for example, as a function of the dimensions, the weight or the depth of focus of the respective focusing lens.

To get to a space-saving exchangeable module, it is possible, for example, to dispose the driven parts of the drive device around the respective focusing lens, for example in a spatial area, which extends concentrically around the expansion direction of the laser beam or around the focusing lens, respectively. Based on this concept, a particularly compact exchangeable module and accordingly a particularly compact machining head can be realized. Despite the compact arrangement of the driven parts of the drive device, a comfortable replacement of the focusing lens of an exchangeable module is possible in this case, especially because the focusing lens as well as the driven parts of the focusing lens are separated in each case from the stationary part of the machining head in response to a separation of the exchangeable module from the stationary part of the machining head, wherein the driven parts can be disposed around the focusing lens such that the focusing lens is easily accessible at least from one side of the exchangeable module at least after the removal of the exchangeable module from the stationary part of the machining head.

To realize the exchangeable module comprising a fluid drive unit, provision can be made, for example, to configure the carrying structure of the exchangeable module as a hollow part and to configure a driven part of the drive unit as a piston unit, wherein the piston unit is disposed in a cavity of the hollow part and is guided on a cavity wall of the cavity. The piston unit can be disposed such that it can be moved coaxially to the expansion direction of the laser beam.

For example, the piston unit can encompass a passage duct for the laser beam, wherein the focusing lens is disposed in the passage duct and is attached to the piston unit.

An alternative of this embodiment is characterized in that the drive unit comprises a first pressure chamber and a second pressure chamber and that the piston unit encompasses a first piston surface and a second piston surface, wherein the first pressure chamber is defined by a first wall section of the cavity wall and by the first piston surface and the second pressure chamber is defined by a second wall section of the cavity wall and by the second piston surface and wherein the respective pressure chambers are configured such that the volume of the first pressure chamber and the volume of the second pressure chamber are increased or decreased, respectively, in the opposite direction, in response to a movement of the piston unit along the cavity wall. To provide for a movement of the piston unit, the first pressure chamber can be flooded with a first fluid and the second pressure chamber can be flooded with a second fluid. By specifically flooding the first pressure chamber or the second pressure chamber, respectively, with the first or the second fluid, respectively, the piston unit can be moved along the cavity wall, namely either in the direction of the first pressure chamber or in the direction of the second pressure chamber.

The first pressure chamber and/or the second pressure chamber can be configured concentrically to the expansion direction of the laser beam. Accordingly, the first piston surface and/or the second piston surface could encompass the form a ring, which is concentric relative to the expansion direction of the laser beam. This design of the respective pressure chambers and piston surfaces provides for the realization of a particularly compact drive device. This drive device can be realized by means of simple means and thus in a cost-efficient manner.

The exchangeable module according to the invention also provides for the integration of a supply with process gases for impacting machining processes. The delivery of the process gas can be realized such that the process gases—even though they are delivered at a high pressure—do not exert any forces or only small forces, respectively, onto the focusing lens. The drive device for moving the focusing lens can thus be designed such that only small forces are required to move the focusing lens, even if process gases are delivered at a high pressure.

The exchangeable module according to the invention also provides for the integration of a supply with additional media, for example with gases, which can be used to clean and/or to cool the focusing lens. The delivery of such gases can also be realized such that these gases—even if they are delivered at an excess pressure—do not exert any forces or only small forces, respectively, onto the focusing lens. The drive device for moving the focusing lens can thus be designed such that only small forces are required for moving the focusing lens, even if the mentioned gases are delivered at an excess pressure.

Further details of the invention and in particular exemplary embodiments of the invention will be defined below by means of the enclosed drawings.

FIG. 1 shows a laser machining tool for machining a workpiece by means of a laser beam, having a modular machining head according to the invention, wherein an exchangeable module according to the invention comprising a focusing lens is brought into a stationary operating position with reference to the stationary part of the machining head;

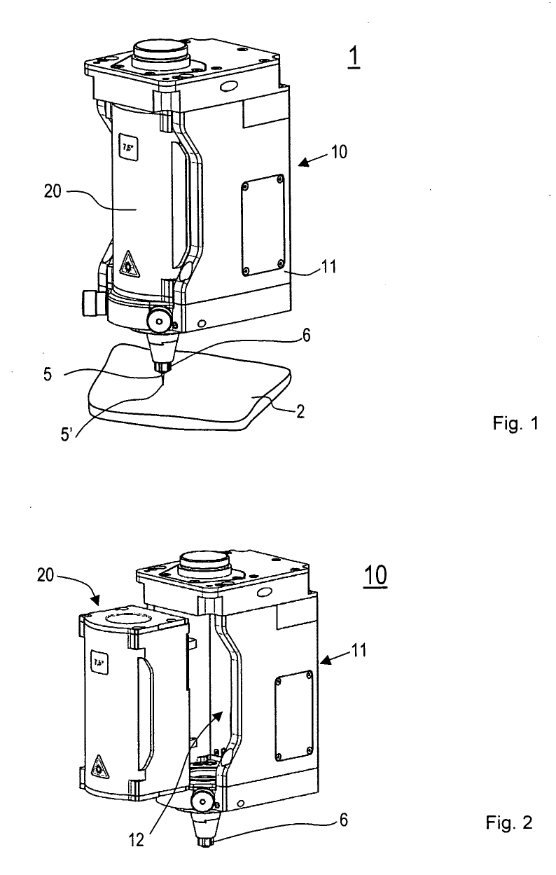

FIG. 2 shows the machining head according to FIG. 1, wherein the exchangeable module is removed from the stationary operating position and is separated from the stationary part of the machining head;

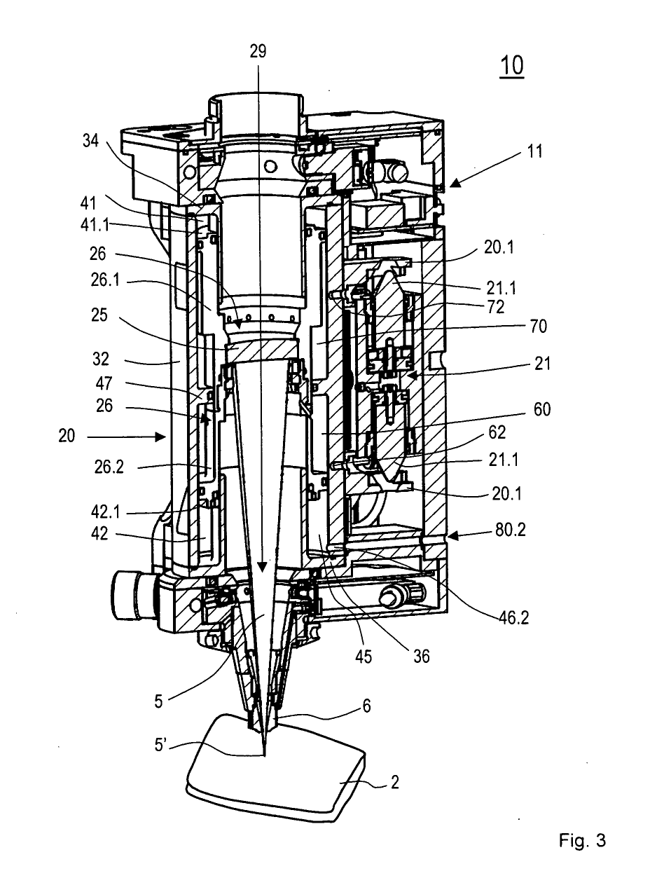

FIG. 3 shows the machining head according to FIG. 1 in a three-dimensional illustration, wherein the machining head is illustrated in a section along the expansion direction of the laser beam;

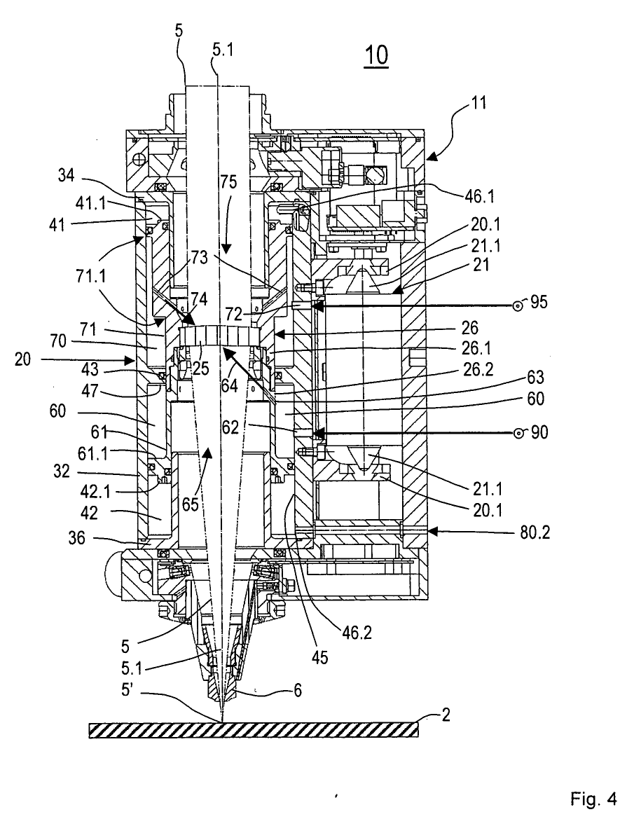

FIG. 4 shows the machining head according to FIG. 1 in a section along the expansion direction of the laser beam;

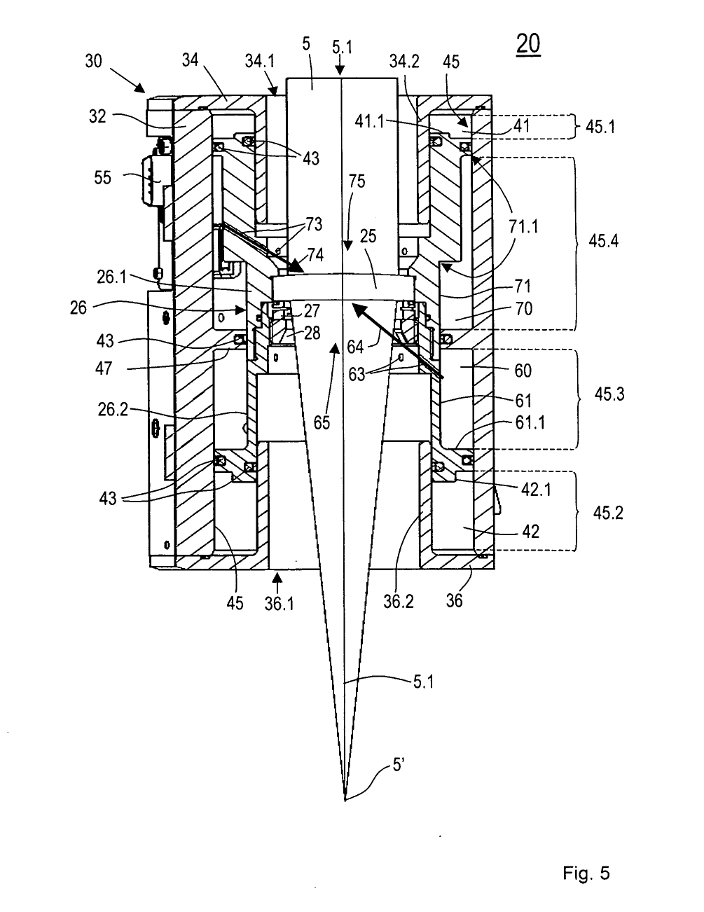

FIG. 5 shows an exchangeable module according to the invention for the machining head according to FIG. 1, wherein the exchangeable module is illustrated in a section along the expansion direction of the laser beam;

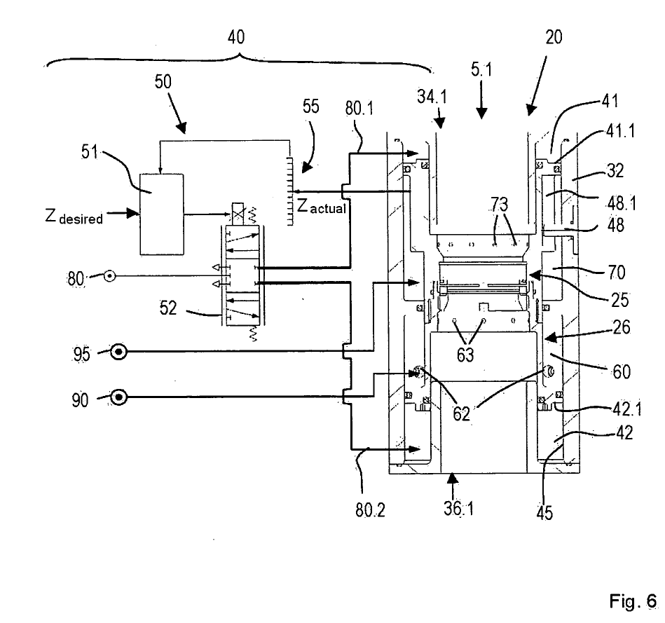

FIG. 6 shows the exchangeable module according to FIG. 4 in a section along the expansion direction of the laser beam, together with a fluid drive for moving a focusing lens.

FIG. 1 shows a laser machining tool 1, which is equipped with a machining head 10 according to the invention. In the instant example, the laser machining tool 1 is illustrated in operation in response to a machining of a workpiece 2 by means of a laser beam 5, wherein the laser beam 5 escapes from an outlet opening (which can be seen in FIGS. 2 and 3) of a nozzle 6. In the instant case, the laser beam 5 is focused onto a surface of the workpiece 2 (one surface of the workpiece 2 is located in the focus 5′ of the focusing lens) by means of a focusing lens, which will be defined below in context with FIGS. 3-5. The nozzle 6 furthermore allows for a flow of a process gas in the vicinity of the laser beam 5 to be guided onto the workpiece 2, so as to be able to impact the machining of the workpiece 2 with the help of the process gas. The laser machining tool 1 is illustrated in FIG. 1 in a simplified manner: the machining head 10 can be moved relative to the workpiece 2, for example by means of a robotic arm, which is not illustrated in FIG. 1.

As is shown in FIGS. 1 and 2, the machining head 10 comprises a stationary part 11 in the form of a housing, which is open on one side and which encloses a space 12 for an exchangeable module 20. The exchangeable module 20 can be inserted into and pulled out of the space 12 accordingly at right angles to the expansion direction 5.1 of the laser beam 5. In the illustration according to FIG. 1, the exchangeable module 20 is in a stationary operating position with reference to the stationary part 11 of the machining head 10. FIG. 2 shows that the exchangeable module 20 can be separated as a whole from the stationary part 11 of the machining head 10, without the need to separate the stationary part into individual components.

FIGS. 3 and 4 show structural details of the stationary part 11 of the machining head 10 and of the exchangeable module 20, wherein the exchangeable module 20 is illustrated in a stationary operating position with reference to the stationary part 11. FIG. 5 separately shows the exchangeable module 20, which is separated from the stationary part 11, wherein further details of the exchangeable module 20 (which cannot be seen in FIGS. 3 and 4) are made visible.

To be able to bring the respective exchangeable module 20 accurately into the stationary operating position and to be able to hold it in the stationary operating position, the stationary part 11 of the machining head 10 is provided with a centering and holding device 21 for the exchangeable module 20. The holding device 21 comprises two centering pins 21.1, one end of which is in each case configured in a conical manner and which can be moved by means of a (non-illustrated) control system such that their conical end can in each case engage with corresponding center holes, which are configured in the two arms 20.1, which are attached to an outer side of the exchangeable module 20 (FIG. 3). By moving the centering pins 21.1 into the mentioned center holes in the arms 20.1, the exchangeable module 20 can be brought into the stationary operating position in a centered manner and can be held in the stationary operating position. Accordingly, the two centering pins 21.1 can be moved out of the center holes in the arms 20.1, so as to release the arms 20.1 and to provide for a removal of the exchangeable module 20 out of the space 12.

As is shown in FIGS. 3-5, the exchangeable module 20 comprises a focusing lens 25, which in the instant example consists of one lens. The focusing lens 25 is disposed such that the optical axis of the focusing lens 25 coincides with the expansion direction 5.1 of the laser beam 5 (coaxial arrangement) when the exchangeable module 20 is brought into the stationary operating position.

To attain that the laser beam 5 can be focused to different distances relative to the nozzle 6, the focusing lens 25 is furthermore disposed such that its focus 5′ can be moved along the expansion direction 5.1 of the laser beam or of the optical axis of the focusing lens 25 (coaxially), respectively, when the exchangeable module 20 is brought into the stationary operating position.

For this purpose, the exchangeable module 20 comprises a carrying structure 30 for the focusing lens 25, which allows for a movement of the focusing lens 25 coaxially to the expansion direction 5.1 when the exchangeable module (and thus also the support structure 30) is brought into the stationary operating position.

The support structure 30 has a plurality of functions: it serves as a housing for the exchangeable module 20 and for guiding the focusing lens 25 in response to a movement of the focusing lens 25 along the expansion direction 5′ of the laser beam and it furthermore forms a part of a drive device 40 (FIG. 6), which can be actuated fluidically, for moving the focusing lens 25.

As is shown in FIG. 5 in connection with FIGS. 3, 4 and 6, the carrying structure 30 is configured as a hollow part and comprises:
a side wall 32, which laterally defines a cylindrical cavity, wherein the inner side of the side wall 32 forms a cavity wall 45, which—based on the longitudinal direction of the side wall 32—encompasses a circular cross section;
a locking plate 34, which is attached to one end of the side wall 32 and which encompasses a circular inlet opening 34.1 for the laser beam 5, wherein a tube 34.2 comprising a round cross section, which is disposed coaxially to the cavity wall 45 and which encloses the inlet opening 34.1, is attached to the locking plate 34;
a locking plate 36, which is attached to the other end of the side wall 32 and which encompasses a circular outlet opening 36.1 for the laser beam 5, wherein a tube 36.2 comprising a round cross section, which is disposed coaxially to the cavity wall 45 and which encloses the outlet opening 36.1, is attached to the locking plate 36. The locking plate 34 defines the exchangeable module 20 on the inlet side of the laser beam 5 and the locking plate 36 defines the exchangeable module 20 on the outlet side of the laser beam 5.

As is indicated in FIGS. 3-5, the tube 34.2 and the tube 36.2 are in each case disposed relative to the cavity wall 45 such that a ring-shaped gap is configured in each case between the cavity wall 45 and each of the tubes 34.2 and 36.2. FIGS. 3-5 furthermore show that the cavity wall 45, the inlet opening 34.1, the circular outlet opening 36.1 and the tubes 34.2 and 36.2 are in case disposed coaxially or concentrically, respectively, relative to the expansion direction 5.1 when the exchangeable module 20 is in the stationary operating position.

The focusing lens 25 is mounted into a lens holder 26, which, for assembly reasons, is comprised of two tubular parts 26.1 and 26.2 and encompasses a passage duct 29 for the laser beam 5 (FIG. 3). The focusing lens 25 is disposed in the passage duct 29 and is attached to the lens holder 26 by means of a spring ring 27 and a screw nut 28, so as to ensure a stable fit of the focusing lens 25.

To be able to ensure an accurately controllable movement of the focusing lens 25 relative to the support structure 30 of the exchangeable module, the lens holder 26 is furthermore formed such that it can be disposed and guided in the cavity, which is enclosed by the carrying structure 30 and so that it can furthermore serve as a piston unit of the drive unit 40, which can be actuated by means of a fluid. For this purpose, the lens holder 26 is configured as follows:

a) As is shown in FIGS. 3-6, the lens holder 26 is dimensioned such that—when it is inserted into the exchangeable module 20—the part 26.1 of the lens holder 26 projects into the ring-shaped gap, which is configured between the cavity wall 45 and the tube 34.2, and such that the part 26.2 of the lens holder 26 projects into the ring-shaped gap, which is configured between the cavity wall 45 and the tube 36.2. The end of the lens holder 26 (part 26.1), which faces the locking plate 34, is formed such that the outer side of the lens holder 26 abuts on the cavity wall 45 in a positive manner and such that the inner side of the lens holder 26 abuts on the tube 34.2 in a positive manner. Accordingly, the end of the lens holder 26 (part 26.2), which faces the locking plate 36, is formed such that the outer side of the lens holder 26 abuts on the cavity wall 45 in a positive manner and such that the inner side of the lens holder 26 abuts on the tube 36.2 in a positive manner. The lens holder 26 is consequently guided on the cavity wall 45 and on the tubes 34.2 and 36.2.

b) The extension of the lens holder 26 in the longitudinal direction of the side wall 32 of the exchangeable module 20 is chosen such that the lens holder 26 can be moved about a predetermined distance coaxially to the direction of extension 5.1 of the laser beam along the cavity wall 45. To prevent a rotation of the lens holder 26, a pin 48 can be inserted into the side wall 32 such that the pin 48 engages with a groove 48.1, which is configured on a side of the lens holder 26 parallel to the optical axis of the focusing lens 25 (FIG. 6).

c) The end of the lens holder 26 (part 26.1), which faces the locking plate 34, forms a ring-shaped surface, which is sealed from the cavity wall 45 and the tube 34.2 by means of seals 43 and which serves as a first piston surface 41.1 of the drive unit 40. Accordingly, the end of the lens holder 26 (part 26.2), which faces the locking plate 36, forms a ring-shaped surface, which is sealed from the cavity wall 45 and the tube 36.2 by means of seals 43 and which serves as a second piston surface 42.1 of the drive unit 40. As will be explained in more detail below, a pressurized fluid can be applied onto the two piston surfaces 41.1 and 42.1, so as to be able to move the lens holder 26 relative to the carrying structure 30. The piston surfaces 41.1 and 42.1 or the lens holder 26, respectively, can thus be considered to be driven parts of the drive unit 40.

As is shown in FIGS. 3-6, the drive unit 40 furthermore comprises a first pressure chamber 41 and a second pressure chamber 42. The first pressure chamber 41 is defined by the first piston surface 41.1 and the locking plate 34 in the area of a first wall section 45.1 of the cavity wall 45 within the ring-shaped gap, which is configured between the cavity wall 45 and the tube 34.2. Accordingly, the second pressure chamber 42 is defined by the second piston surface 42.1 and the locking plate 36 in the area of a second wall section 45.2 of the cavity wall 45 within the ring-shaped gap, which is configured between the cavity wall 45 and the tube 36.2. The pressure chambers 41 are configured such that the volume of the first pressure chamber 41 and the volume of the second pressure chamber 42 are increased or decreased, respectively, in the opposite direction (as a function of the direction of the movement) in response to a movement of the lens holder 26 along the cavity wall 45.

The first pressure chamber 41 can be filled with a first fluid via an inlet opening 46.1 in the side wall 32 of the carrying structure 30. Accordingly, the second pressure chamber 42 can be filled with a second fluid via an inlet opening 46.2 in the side wall 32 of the carrying structure 30.

In the instant case, differences between the respective pressure of the first fluid in the first pressure chamber 41 and the respective pressure of the second fluid in the second pressure chamber 42 provide for a displacement of the lens holder 26 along the expansion direction 5.1 of the laser beam 5. Accordingly, the position of the focusing lens 25 relative to the carrying structure 30 can be monitored by means of a regulation of the pressure of the respective fluid in the first or second pressure chamber 41 or 42, respectively, and can be changed about predetermined distances along the expansion direction 5.1 of the laser beam 5.

As is indicated in FIGS. 3-6, the drive device 40 (as supply device for a first fluid), comprises a pressure line 80.1 for a first fluid, which leads into the stationary part 11 of the machining head 10. The inlet opening 46.1 is disposed in the side wall 32 of the exchangeable module 20 such that the pressure line 80.1 is automatically connected to the inlet opening 46.1 or to the first pressure chamber 41, respectively, when the exchangeable module 20 is brought into the stationary operating position. Accordingly, the drive device 40 (as supply device for a second fluid), comprises a pressure line 80.2 for a second fluid, which leads into the stationary part 11 of the machining head 10. The inlet opening 46.2 is disposed in the side wall 32 of the exchangeable module 20 such that the pressure line 80.2 is automatically connected to the inlet opening 46.2 or to the second pressure chamber 42, respectively, when the exchangeable module 20 is brought into the stationary operating position.

As is indicated in FIG. 6, a fluid, which is removed from a pressure line 80 and which can be supplied to the pressure lines 80.1 and 80.2 via a controllable regulating valve 52, can in each case be introduced into the pressure lines 80.1 and 80.2. The regulating valve 52 can be configured as a proportional valve, for example, which makes it possible to control the respective pressure in the pressure lines 80.1 or 80.2, respectively, and thus in the first pressure chamber 41 or in the second pressure chamber 42, respectively, independent on one another as a function of control signals.

The drive device 40 furthermore comprises a monitoring system 50, which monitors the positioning of the focusing lens 25 and which controls a readjustment of the focusing lens according to corresponding specifications of the control system of the laser machining tool 1 (as a function of the respective machining process, which is to be carried out by the laser machining tool 1). The monitoring system 50 comprises test equipment 55 for determining the position of the focusing lens 25 and a controller 51. The test equipment 55 generates signals, which represent the current position (“actual value”) of the focusing lens 25 (illustrated as Z_{act} in FIG. 6). The controller 55 has the object of comparing the signals of the test equipment 55 to signals, which specify a set value for the position of the focusing lens 25, which is predetermined by the control system of the laser machining tool 1 (illustrated as Zₛₑₜ in FIG. 6) and—in response to a deviation between set value and actual value—to act on the regulating valve 52 by means of suitable signals such that the focusing lens 25 is brought into the predetermined required position.

As is shown in FIG. 5, the test equipment 55 can be integrated into the exchangeable module 20. The test equipment 55 can be configured, for example, as a contact-free measuring system, for example on the basis of a measuring unit (which can be read by means of optical or magnetic means, for example), which can be disposed on the lens holder 26, and on the basis of a corresponding reading head, which can be attached to the carrying structure 30 and which is suitable for reading the measuring unit.

A gas or a suitable liquid, for example, can serve as first or second fluid, respectively, of the drive device 40. In particular a coolant (for example deionized water) would be suitable as liquid, which provides the advantage that the coolant can ensure an effective cooling of the lens holder 26 in response to high laser powers.

The exchangeable module 20 is designed such that process gases can be guided from a space, which adjoins the focusing lens 25 at the outlet side of the laser beam 5, through the outlet opening 36.1 of the exchangeable module 20 and through the nozzle 6 of the machining head 10 onto the workpiece 2, which is to be machined.

To ensure a supply with process gas, a process gas chamber 60, which can be flooded with a process gas or with a mixture of process gases, respectively, is integrated into the exchangeable module 20. As is shown in FIG. 5, the lens holder 26 encompasses, on a side located opposite to a third wall section 45.3 of the cavity wall 45, a first wall area 61, which, together with the third wall section 45.3 of the cavity wall 45, defines the process gas chamber 60.

For the supply with process gas, the stationary part 11 of the machining head 10 is connected to a supply device 90, which provides process gas at a high pressure (for example 25 bar). The side wall 32 of the exchangeable module 20 encompasses a plurality of inlet openings 62 for the process gas in the area of the process gas chamber 60. The inlet openings 62 are in each case disposed such that they are connected to the supply device 90 for the process gas when the carrying structure 30 is brought into the stationary operating position.

The process gas chamber 60 is connected via a plurality of outlet openings 63 for the respective process gas to a space 65, which adjoins the focusing lens 25 on the outlet side of the laser beam 5 and into which a process gas flow 64 (characterized in FIGS. 4 and 5 by an arrow for one of the outlet openings 63), can in each case be introduced from the process gas chamber 60 via each of the outlet openings 63.

As is shown in FIG. 5, the respective process gas flow 64 on the outlet side of the laser beam 5 is directed onto the focusing lens 25 and is diverted from there in the direction towards the outlet opening 36.1 or the focus 5′, respectively. Due to the fact that the respective process gas flow 64 meets the focusing lens 25, the process gas can be used to cool the focusing lens 25, for example.

Due to the fact that the respective process gas flow 64 (as a function of the respective machining process) meets the focusing lens 25 at a high pressure (for example 25 bar), relatively high forces, which act substantially coaxial towards the expansion direction 5.1 of the laser beam in direction of the inlet opening 34.1, can be transferred.

The process gas chamber 60 is designed such that these forces caused by the process gas can be compensated for. For this purpose, the first wall area 61 of the lens holder comprises a piston surface 61.1, to which the process gas is applied and which is disposed such that forces, which are transferred onto the focusing lens 26 by means of the respective process gas flow 64 at the outlet side of the laser beam, are completely or partially compensated for by forces, which are transferred onto the piston surface 61.1 by means of the process gas. To what degree the mentioned forces are compensated for substantially depends on the size of the piston surface 61.1 as compared to the surface of the focusing lens 25, to which the process gas is applied. By suitably choosing the size of the piston surface 61.1, it can thus be attained that all of the forces onto the focusing lens 25, which are induced by the process gas, are accurately compensated for.

The process gas chamber 60 is configured concentrically to the expansion direction 5.1 of the laser beam 5. The piston surface 61.1, to which the process gas can be applied, furthermore encompasses the shape of a ring, which is concentric relative to the expansion direction 5.1 of the laser beam 5. Due to the fact that the process gas chamber 60 is thus disposed coaxially to the expansion direction 5.1 of the laser beam and furthermore in a ring-shaped manner around the focusing lens 25, process-related interfering forces can be eliminated efficiently by means of this arrangement.

Furthermore, the arrangement of the process gas chamber 60 has advantages with reference to process gas exchange, that is, the exchange of a first process gas, which is used in a first machining step, with a second (different) process gas in a second (subsequent) machining step. The respective process gas flows through the process gas chamber 60 in each case on its way to the outlet openings 63. In response to a process gas exchange from the first process gas to the second process gas, the process gas chamber 60 is “rinsed” by the second process gas with the effect that residues of the first process gas are no longer present after a relatively short time. The process gas chamber 60 thus does not form a “dead” space in which remainders of the first process gas can be stored for a long time. A contamination of the second process gas by means of the first process gas, which lasts for a long time, can thus be prevented after a process gas exchange or a special cleaning (rinsing) of the process gas chamber 66 can be carried out within a short time prior to a process gas exchange.

The exchangeable module 20 is designed such that a gas can be applied to the focusing lens 25 on the inlet side of the laser beam 5, for example for cleaning and/or cooling the focusing lens 25.

To ensure a supply of this gas, a gas compartment 70, which can be flooded with gas, for example with cleaned air, is integrated into the exchangeable module 20. As is shown in FIG. 5, the lens holder 26 encompasses, on a side located opposite to a fourth wall section 45.4 of the cavity wall 45, a second wall area 71, which, together with the fourth wall section 45.4 of the cavity wall 45, defines the gas compartment 70. As is shown in FIGS. 3-6, the gas compartment 70 is separated from the process gas chamber 60 by means of a partition wall 47, which is configured (ring-shaped relative to the expansion direction 5.1 of the laser beam 5) and which is sealed from the lens holder 26 by means of a seal 43.

To supply the gas compartment 70 with a gas, the stationary part 11 of the machining head 10 is connected to a supply device 95, which provides the required gas at an excess pressure. In the area of the process gas chamber 70, the side wall 32 of the exchangeable module 20 encompasses a plurality of inlet openings 72 for the respective gas. The inlet openings 72 are in each case disposed such that they are connected to the supply device 95 when the support structure 30 is brought into the stationary operating position.

The gas compartment 70 is connected via a plurality of outlet openings 73 for the respective gas to a space 75, which adjoins the focusing lens 25 on the inlet side of the laser beam 5 and into which a gas flow 74 (characterized in FIGS. 4 and 5 by means of an arrow for one of the outlet openings 73) can be introduced in each case from the gas compartment 70.

As is shown in FIG. 5, the respective gas flow 74 on the inlet side of the laser beam 5 is directed onto the focusing lens 25. Due to the fact that the respective gas flow 74 meets the focusing lens 25, the gas can be used for cleaning and/or cooling the focusing lens 25, for example.

Due to the fact that the respective gas flow 74 meets the focusing lens 25 at an excess pressure, relatively large forces can be transmitted by the gas, which act substantially coaxially to the expansion direction 5.1 of the laser beam in the direction towards the outlet opening 36.1.

The gas compartment 70 is designed such that said forces, which are conditional on the gas, can be compensated for. For this purpose, the second wall area 71 of the lens holder 26 comprises a piston surface 71.1 (the outer edges of the piston surface are characterized in FIGS. 4 and 5 by means of arrows), to which the gas is applied and which is disposed such that forces, which are transferred onto the focusing lens 25 by means of the respective gas flow 74 at the inlet side of the laser beam 5, are completely or partially compensated for by forces, which are transferred onto the piston surface 71.1 by means of the gas. To what degree the mentioned forces are compensated substantially depends on the size of the piston surface 71.1 as compared to the surface of the focusing lens 25, to which the gas is applied. By suitably choosing the size of the piston surface 71.1, it can thus be attained that all of the forces onto the focusing lens 25, which are induced by the gas, are accurately compensated for.

The gas compartment 70 is configured concentrically to the expansion direction 5.1 of the laser beam 5. The piston surface 71.1, to which the gas can be applied, furthermore encompasses the shape of a ring, which is concentric relative to the expansion direction 5.1 of the laser beam 5. Due to the fact that the gas compartment 70 is thus disposed coaxially to the expansion direction 5.1 of the laser beam and furthermore in a ring-shaped manner around the focusing lens 25, the interfering forces, which are contingent on the gas, can be eliminated efficiently by means of this arrangement.

It is pointed out that the fluid drive device 40, which is disclosed in this context, can also be replaced with a drive device of a different design (for example by an electromechanical or electromagnetic or manual drive). Furthermore, the equipment of the exchangeable module 20 with the process gas chamber 60 and the gas compartment 70 are in each case options, which can be combined in an advantageous manner with any drive devices for the focusing lens and which in each case create the basis for the focusing lens 25 to be capable of being readjusted by means of small forces in an accurate manner and so as to be substantially be uninfluenced by interfering forces.

1-22. (canceled)

23. An exchangeable module (20) for a modular machining head (10) of a laser machining tool (1) for machining a workpiece (2) by means of a laser beam (5), comprising a focusing lens (25) for the laser beam (5), at least one driven part (41.1, 42.1, 26) of a drive device (40), and of a carrying structure (30) for the focusing lens (25) and the respective driven parts (41.1, 42.1, 26) of the drive device (40), wherein the focusing lens (25) and the respective driven parts (41.1, 42.1, 26) of the drive device (40) are disposed on the carrying structure (30) such that the focusing lens (25) can be moved relative to the carrying structure (30) by means of the drive device (40), wherein the drive device (40) is configured as a fluid drive and at least one of the respective driven parts (41.1, 42.1, 26) can be driven by means of a pressurized fluid, wherein the carrying structure (30) of the exchangeable module is configured as hollow part and a driven part of the drive unit is configured as piston unit (26), which is disposed in a cavity of the hollow part and which is guided at a cavity wall (45) of the cavity, the piston unit (26) encompasses a passage duct (29) for the laser beam (5) and the focusing lens (25) is disposed in the passage duct and is attached to the piston unit and the at least one driven part (26) encompasses piston surfaces (41.1, 42.1) located opposite the drive device (40), to which the fluid pressure can be applied in each case, so that the focusing lens (25) is capable of being moved forwards and backwards across a readjusting area as a function of the pressure application of the opposite piston surfaces (41.1, 42.1) and is capable of being held fluidically at any position of this readjusting area.

24. A combination of a modular machining head (10) and an exchangeable module (20) according to claim 23, wherein the exchangeable module (20) comprises the drive device (40).

25. The combination according to claim 24, wherein the piston unit (26) can be moved coaxially to the expansion direction (5.1) of the laser beam (5).

26. The combination according to claim 24, wherein the drive unit (40) encompasses a first pressure chamber (41) and a second pressure chamber (42) and the piston unit (26) encompasses a first piston surface (41.1) and a second piston surface (42.1), wherein the first pressure chamber (41) is defined by a first wall section (45.1) of the cavity wall (45) and by the first piston surface (41.1) and the second pressure chamber (42) is defined by a second wall section (45.2) of the cavity wall (45) and of the second piston surface (42.1), and wherein the respective pressure chambers (41, 42) are configured such that the volume of the first pressure chamber and the volume of the second pressure chamber are increased or decreased, respectively, in the opposite direction in response to a movement of the piston unit along the cavity wall (45).

27. The combination according to claim 26, wherein the first pressure chamber (41) can be flooded with a first fluid (80.1) and the second pressure chamber (42) can be flooded with a second fluid (80.2).

28. The combination according to claim 26, wherein the first pressure chamber (41) and/or the second pressure chamber (42) are configured concentrically to the expansion direction (5.1) of the laser beam (5).

29. The combination according to claim 26, wherein the first piston surface (41.1) and/or the second piston surface (42.1) encompasses the shape of a ring, which is concentric relative to the expansion direction (51.1) of the laser beam (5).

30. The combination according to claim 24, wherein the piston unit (26) encompasses, on a side located opposite to a third wall section (45.3) of the cavity wall (45), a first wall area (61), which, together with the third wall section (45.3) of the cavity wall (45), defines a process gas chamber (60), which can be flooded with a process gas, wherein the process gas chamber is connected via at least one outlet opening (63) for the process gas to a space (65), which adjoins the focusing lens (25) on the outlet side of the laser beam and into which a process gas flow (64) can be introduced from the process gas chamber (60) via the outlet opening (63) for the process gas.

31. The combination according to claim 30, wherein the first wall area (61) of the piston unit comprises a piston surface (61.1), to which the process gas can be applied and which is disposed such that forces, which can be transferred onto the focusing lens (25) by means of the process gas flow at the outlet side of the laser beam, can be completely or partially compensated for by forces, which can be transferred onto the piston surface (61.1) by means of the process gas.

32. The combination according to claim 31, wherein the process gas chamber (60) is configured concentrically to the expansion direction (5.1) of the laser beam (5) and wherein the piston surface (61.1), to which the process gas can be applied, encompasses the shape of a ring, which is concentric relative to the expansion direction (5.1) of the laser beam (5).

33. The combination according to claim 24, wherein the piston unit (26) encompasses, on a side located opposite to a fourth wall section (45.4) of the cavity wall (45), a second wall area (71), which, together with the fourth wall section (45.4) of the cavity wall (45), defines a gas compartment (70) for a gas, wherein the gas compartment (70) is connected via at least one outlet opening (73) for this gas to a space (75), which adjoins the focusing lens (25) at the inlet side of the laser beam (5) and into which a gas flow (74) can be introduced from the gas compartment (70) via the outlet opening (73).

34. The combination according to claim 33, wherein the second wall area (71) comprises a piston surface (71.1), to which the gas can be applied, which is disposed such that forces, which can be transferred onto the focusing lens (25) via the gas flow (74) at the inlet side of the laser beam (5), can be completely or partially compensated for by forces, which are transferred onto the piston surface (71.1) by means of the gas.

35. The combination according to claim 34, wherein the gas compartment (70) is configured concentrically to the expansion direction (5.1) of the laser beam (5) and the piston surface (71.1), to which the gas can be applied, encompasses the shape of a ring, which is concentric relative to the expansion direction (5.1) of the laser beam (5).

36. The combination according to claim 24, wherein the exchangeable module (20) comprises a test equipment (55) for determining the position (Z_{actual}) of the focusing lens (25).

37. The combination according to claim 26, wherein the cavity wall (45) encompasses an inlet opening (46.1) for the first fluid and an inlet opening (46.2) for the second fluid and the stationary part (11) of the machining head (10) encompasses a supply device (80.1) for the first fluid and a supply device (80.2) for the second fluid and wherein the inlet openings (46.1, 46.2) for the first and the second fluid are disposed such that the inlet opening (46.1) for the first fluid is connected to the supply device (80.1) for the first fluid and the inlet opening (46.2) for the second fluid is connected to the supply device (80.2) for the second fluid when the carrying structure (30) is brought into the stationary operating position.

38. The combination according to claim 30, wherein the cavity wall (45) encompasses an inlet opening (62) for the process gas and the stationary part (11) of the machining head (10) comprises a supply device (90) for process gas and wherein this inlet opening (62) is disposed such that it is connected to the supply device (90) for the process gas when the carrying structure (30) is brought into the stationary operating position.

39. The combination according to claim 33, wherein the cavity wall (45) encompasses an inlet opening (72) for a gas, which can be introduced into the gas compartment (70) and the stationary part (11) of the machining head comprises a supply drive (95) for this gas and wherein this inlet opening (72) is disposed such that it is connected to the supply device (95) for this gas when the carrying structure (30) is brought into the stationary operating position.

40. Combination according to claim 24, wherein the machining head (10) comprises a stationary part (11) and the carrying structure (30) of the module (20) can be brought into a stationary operating position relative to the stationary part (11) of the machining head (10).

41. A laser machining tool (1) comprising a combination of a modular machining head (10) and an exchangeable module (20) according to claim 24.
